(19) United States
(12) Patent Application Publication
(10) Pub. No.: US 2013/0124562 A1
(43) Pub. Date: May 16, 2013

(54) EXPORT OF CONTENT ITEMS FROM MULTIPLE, DISPARATE CONTENT SOURCES

(71) Applicants: Quentin Gary Christensen, Redmond, WA (US); Adam David Harmetz, Seattle, WA (US); Ryan Thomas Wilhelm, Kirkland, WA (US); Julian Zbogar Smith, Redmond, WA (US); Yingtao Dong, Redmond, WA (US); John D. Fan, Redmond, WA (US); Thottam R. Sriram, Redmond, WA (US); Radhakrishnan Sundaresan, Redmond, WA (US); Anupama Janardhan, Seattle, WA (US); Graham Lee McMynn, Redmond, WA (US); Ramanathan Somasundaram, Bothell, WA (US); Jessica Anne Alspaugh, Seattle, WA (US); Bradley Stevenson, Seattle, WA (US)

(72) Inventors: Quentin Gary Christensen, Redmond, WA (US); Adam David Harmetz, Seattle, WA (US); Ryan Thomas Wilhelm, Kirkland, WA (US); Julian Zbogar Smith, Redmond, WA (US); Yingtao Dong, Redmond, WA (US); John D. Fan, Redmond, WA (US); Thottam R. Sriram, Redmond, WA (US); Radhakrishnan Sundaresan, Redmond, WA (US); Anupama Janardhan, Seattle, WA (US); Graham Lee McMynn, Redmond, WA (US); Ramanathan Somasundaram, Bothell, WA (US); Jessica Anne Alspaugh, Seattle, WA (US); Bradley Stevenson, Seattle, WA (US)

(73) Assignee: Microsoft Corporation, Redmond, WA (US)

(21) Appl. No.: 13/293,146

(22) Filed: Nov. 10, 2011

(51) Int. Cl. G06F 17/30

(52) U.S. Cl. 707/770; 707/E17.032; 707/E17.134

(57) ABSTRACT

Technologies are described herein for exporting content items from multiple disparate content sources to a single repository. Query parameters are received for locating content items hosted by one or more content servers of different types for export. Native search queries are generated for each content server from the query parameters and are executed on each content server. An export manifest listing the content items for export is built from query results received from the content servers. Each content item listed in the export manifest is then retrieved from the corresponding content server and stored in a single export repository.

### BACKGROUND

A company involved in litigation may be obligated to locate and disclose all relevant “evidence” to opposing counsel. Such evidence may include a variety of electronic content, including email messages, documents and other files, list and other contents maintained on websites, and the like. This electronic content may be spread across disparate systems including on premise (local) and cloud-based servers, each having a different process of indexing, searching, and exporting information. Identifying, preserving, and processing for export the electronic content across the multiple servers may be difficult, time consuming, and expensive. The amount of data that the company is required to sort through and produce may be vast. In addition, the lack of tools to efficiently locate relevant electronic content across disparate systems and export the content to a single archive for disclosure may increase litigation costs.

It is with respect to these considerations and others that the disclosure made herein is presented.

### SUMMARY

Technologies are described herein for exporting content items from multiple disparate content sources to a single repository. Utilizing the technologies described herein, a user may initiate multiple, concurrent export operations of content items on one or more content servers that match a query and store the exported items in one place. For example, a user involved in an e-discovery investigation may utilize the systems, methods, and user interfaces described herein to execute targeted search queries against an identified “virtual archive” of items hosted on multiple types of content servers to produce a manifest of relevant content items. The manifest may then be utilized to automatically and concurrently initiate export of the identified content items from the corresponding content servers to a repository located on the user's local hard disk or a file share.

According to embodiments, query parameters are received for locating content items for export hosted by one or more content servers of different types. Native search queries are generated for each content server from the query parameters and are executed on each content server. An export manifest listing the content items for export is built from query results received from the content servers. Each content item listed in the export manifest is then retrieved from the corresponding content server and stored in a single export repository.

It will be appreciated that the above-described subject matter may be implemented as a computer-controlled apparatus, a computer process, a computing system, or as an article of manufacture such as a computer-readable medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a block diagram showing aspects of an illustrative operating environment and software components provided by the embodiments presented herein;

FIG. 2 is a flow diagram showing one method for exporting content items from multiple disparate content sources to a single repository, according to embodiments described herein;

FIG. 3 is a screen diagram showing an illustrative user interface for selecting one or more query specifications for locating content items for export, according to embodiments described herein; and

FIG. 4 is a block diagram showing an illustrative computer hardware and software architecture for a computing system capable of implementing aspects of the embodiments presented herein.

### DETAILED DESCRIPTION

The following detailed description is directed to technologies for exporting content items from multiple disparate content sources to a single repository. While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

In the following detailed description, references are made to the accompanying drawings that form a part hereof and that show, by way of illustration, specific embodiments or examples. In the accompanying drawings, like numerals represent like elements through the several figures.

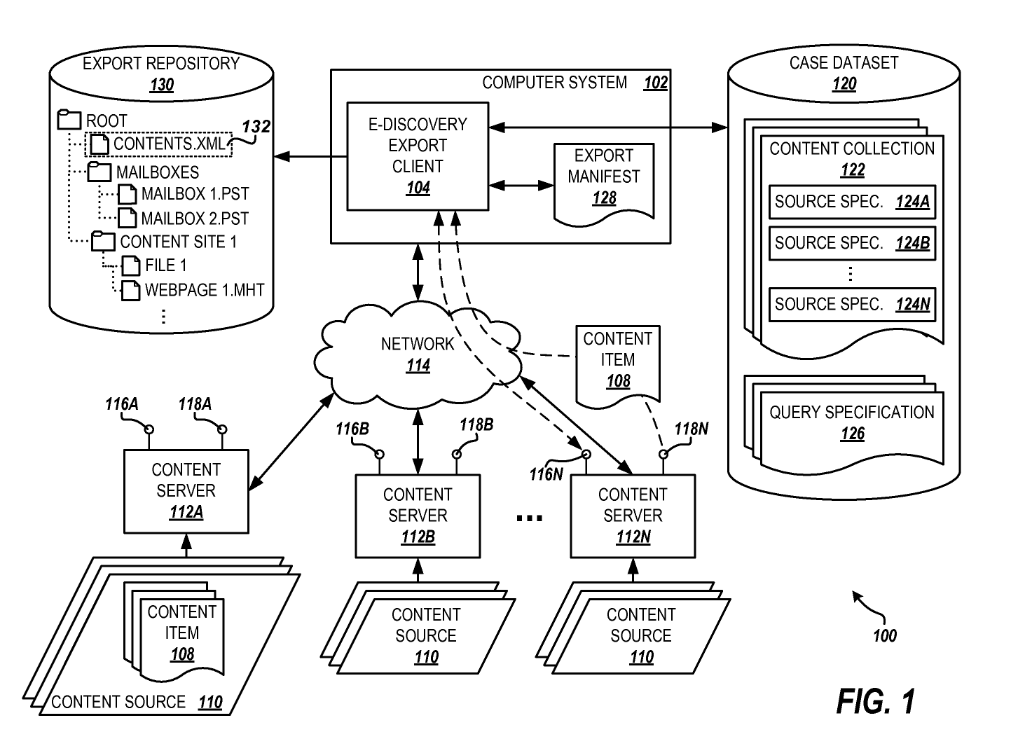

FIG. 1 shows an illustrative operating environment 100 including software components for exporting content items from multiple disparate content sources to a single repository, according to embodiments provided herein. The environment 100 includes a computer system 102. In one embodiment, the computer system 102 represents a user computing device, such as a personal computer (“PC”), a desktop workstation, a laptop, a notebook, a tablet, a mobile device, a personal digital assistant (“PDA”), a game console, a set-top box, a consumer electronics device, and the like. In other embodiments, the computer system 102 may represent one or more Web and/or application servers executing web-based application programs and accessed over a network 114 by a user using a Web browser or other client application executing on a user computing device.

An e-discovery export client 104 may execute on the computer system 102. In one embodiment, the e-discovery export client 104 may be a component of a larger e-discovery application that may be utilized by a user to identify, preserve, and export a set of content items relevant to a business issue or event, such as litigation or other legal matters, for example. The e-discovery export client 104 may allow the user to utilize targeted search queries to locate relevant content items from a “virtual archive” comprising content items 108 stored in multiple content sources 110. Examples of a content source 110 may include an email mailbox, a document library, a fileshare, a discussion thread, a Web log (“blog”), a website, and the like. Examples of content items 108 may include email messages, documents or files, webpages, an entry in a discussion thread, a blog post, a wiki page entry, and the like. The e-discovery export client 104 may then initiate an export of the located content items 108 from the various content sources 110 for storage in an export repository 130, as will be described below.

According to embodiments, the content items 108 may be hosted by, stored on, and/or accessed through multiple, disparate content servers 112A-112N (also referred to herein generally as content servers 112 or content server 112). The e-discovery export client 104 may access the content servers 112 over a network 114. The network 114 may be a local-area network (“LAN”), a wide-area network (“WAN”), the Internet, or any other networking topology known in the art that connects the computer system 102 to the content servers 112. The content servers 112 may include local servers located in the same location or on the same corporate LAN/WAN as the computer system 102, as well as cloud-based server resources accessed by the e-discovery export client 104 over the Internet.

In one embodiment, the content servers 112 include one or more email servers, such as MICROSOFT® EXCHANGE SERVER email servers from Microsoft Corporation of Redmond, Wash. The content servers 112 may also include one or more content site servers, such as MICROSOFT® SHAREPOINT® servers, also from Microsoft Corporation. The content servers 112 may also include one or more file servers, NAS storage devices, or other file and document storage systems. In other embodiments, the content servers 112 may include document management servers, database servers, Web servers, and other data and content servers known in the art.

Each content server 112A-112N may provide a corresponding search interface 116A-116N (also referred to herein as search interfaces 116 or search interface 116) for searching the content items 108 hosted on the content server. For example a content server 112A comprising an email server may provide a search interface 116A for searching email messages contained in email mailboxes, such as the Exchange Web Services (“EWS”) interface provided by MICROSOFT® EXCHANGE SERVER email servers. In another example, a content server 112B comprising a content site server may provide a search interface 116B for searching documents contained in document libraries, content pages contained in content sites or sub-sites, and/or list items contained in lists, such as the SharePoint Client Object Model interface provided by MICROSOFT® SHAREPOINT® servers. According to embodiments, each content server 112 may maintain one or more indexes supporting the searching of associated content items 108 through the search interface 116.

Each content server 112A-112N may further provide a corresponding item retrieval interface 118A-118N (also referred to herein as item retrieval interfaces 118 or item retrieval interface 118) for retrieving the content items 108 located through the search interface 116. In addition, the item retrieval interfaces 118 may further provided context information associated with each content item 118 retrieved, such as metadata regarding the item retrieved from the search index, for example. In one embodiment, the item retrieval interface 118 may comprise the same application programming interface (“API”) as the search interface 116. The search interfaces 116 and item retrieval interfaces 118 may comprise SOAP-based Web services, Java RMI calls, WINDOWS® communication foundation (“WFC”) services, or any combination of these and other interfaces known in the art.

The e-discovery export client 104 may access a case dataset 120 that defines the various content sources 110 containing the content items 108 comprising the virtual archive of items to be searched and exported. The case dataset 120 may represent an XML file, one or more database tables in a database, or any other structured storage mechanism known in the art stored on or accessible to the computer system 102. The case dataset 120 may contain one or more content collections 122, each content collection 122 comprising one or more source specifications 124A-124N (also referred to herein as source specifications 124 or source specification 124). Each source specification 124 may identify a specific content source 110 containing content items 108 that collectively make up the virtual archive. For example, one source specification 124A may identify a specific email mailbox hosted on an email server. Another source specification 124B may identify a document library accessed through a content site server hosting a content site.

Organizing the source specifications 124 into content collection(s) 122 may allow configuration options for the virtual archive to be applied at a content collection level, such as how duplicate content items 108 will be handled during export, whether multiple versions of the content items will be exported when available, and the like. In addition, filters may be applied at the content collection level to further limit the content items 108 from the specified content sources 110 to be included in the virtual archive. Filters may include date-ranges for email messages sent or documents created or modified, author/sender of documents or email messages, keyword filters, and the like. In other embodiments, filters may further be specified at a content source level, i.e. per source specification 124, or for the entire virtual archive defined in the case dataset 120.

The case dataset 120 may further contain one or more query specifications 126. The query specifications 126 may define queries that are used to search the content sources 110 comprising the virtual archive as defined by the source specifications 124 to locate relevant content items 108. Each query specification 126 may include a number of query parameters, such as a free-text query parameter, a date-range parameter, and author parameter, and the like. The free-text query parameter may comprise keywords, junction words, grouping parenthesis, property/value pairs, and the like in any suitable syntax, such as a knowledge query language (“KQL”) query.

According to embodiments, the syntax of the free-text query parameter may be independent of the form or syntax of the query supported by the search interface 116 of each content server 112. The e-discovery export client 104 may parse the free-text query parameter and translate the query to the proper form and/or syntax for the content servers 112 when the query is executed. The date-range parameter may be applied to specific properties of content items 108 depending on their type, such as the sent date of email messages, the creation or modification date of documents or files, the posting date for discussion entries, and the like. Similarly, the author parameter 214 may be applied to specific properties of content items 108 depending on their type, such as the sender of email messages, the creator of documents, the poster of discussion entries, and the like.

Each query specification 126 may further include a definition of a scope for the query. The query scope may specify content collections 122 and/or source specifications 124 from the case dataset 120 that identify the content sources 110 containing content items 108 to be searched by the query. The content collections 122, source specifications 124, and query specifications 126 in the case dataset 120 may be built by a user utilizing the e-discovery application described above, based on content sources and query parameters deemed potentially relevant to the litigation or other business issue/event at hand.

For example, the e-discovery application may include a user interface for allowing the user to define the query parameters and query scope of the query specifications 126 as well as view query statistics regarding the execution of the query against the content servers 112 and preview matching content items 108, as described in co-pending U.S. patent application Ser. No. ______ filed concurrently with this application, having Attorney Docket No. 333954.01, and entitled “Locating Relevant Content Items Across Multiple Disparate Content Sources,” which is incorporated herein by this reference in its entirety.

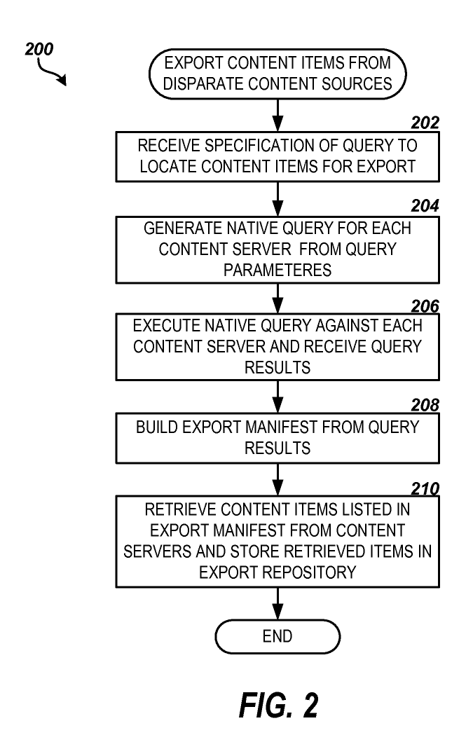

As will be described below in regard to FIG. 2, the e-discovery export client 104 may retrieve the query parameters defined by one or more query specifications 126 and generate a native search query for each content server 112 hosting the content sources 110 specified in the query scope. The e-discovery export client 104 may then execute the native search queries against each content server 112, using the search interfaces 116, for example, and use the query results received from the content servers to build an export manifest 128. The export manifest 128 may contain a list of content items 108 to be exported, including an identifier for each content item, a type of the item, an identification of the corresponding content source 110 and/or content server 112, and the like. The export manifest 128 may be stored in a CSV file, an XML file, one or more database tables in a database, or some other structured storage mechanism available to the e-discovery export client 104.

Next, the e-discovery export client 104 may utilize the export manifest 128 to retrieve the listed content items 108 and any context data associated with the items from the corresponding content servers 112, using the item retrieval interfaces 118, for example, and store the retrieved items and associated context data in an export repository 130. The export repository 130 may be stored on a local storage device of the computer system 102 or on a file server or other remote storage device available to the e-discovery export client 104 over the network 114. In one embodiment, the export repository 130 may be organized as a virtual file system, with a directory hierarchy grouping exported content items 108 of the same type, from the same content source 110, from the same content server 112, and/or the like.

The export repository 130 may further contain a contents listing 132. The contents listing 132 may comprise metadata regarding the content items 108 stored in the export repository 130, including an identifier of each content item and its location in the directory hierarchy of the repository. The contents listing 132 may be stored in the export repository 130 as a text document, an XML file, a CSV file, or some other structured file format. In one embodiment, the contents listing 132 is stored in the export repository 130 at a root level of the directory hierarchy. In other embodiments, the contents listing 132 may comprise an XML file in a format according to the Electronic Discovery Reference Model (“EDRM”). Additionally, the e-discovery export client 104 may add custom XML tags to the EDRM-based contents listing 132 file in order to support additional metadata information, as will be described in more detail below.

Referring now to FIG. 2, additional details will be provided regarding the embodiments presented herein. It should be appreciated that the logical operations described with respect to FIG. 2 are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as operations, structural devices, acts, or modules. These operations, structural devices, acts, and modules may be implemented in software, in firmware, in special purpose digital logic, and any combination thereof. It should also be appreciated that more or fewer operations may be performed than shown in the figures and described herein. The operations may also be performed in a different order than described.

FIG. 2 illustrates one routine 200 for exporting content items from multiple disparate content sources to a single repository, according to one embodiment. The routine 200 may be performed by the e-discovery export client 104 executing on the computer system 102, for example. It will be appreciated that the routine 200 may also be performed by other modules or components executing on the computer system 102, or by any combination of modules, components, and computing devices. The routine 200 begins at operation 202, where the e-discovery export client 104 receives a specification of a query for locating the relevant content items 108 in the virtual archive for export. For example, the e-discovery export client 104 may receive an identifier of one or more query specifications 126 defined in the case dataset 120 described above.

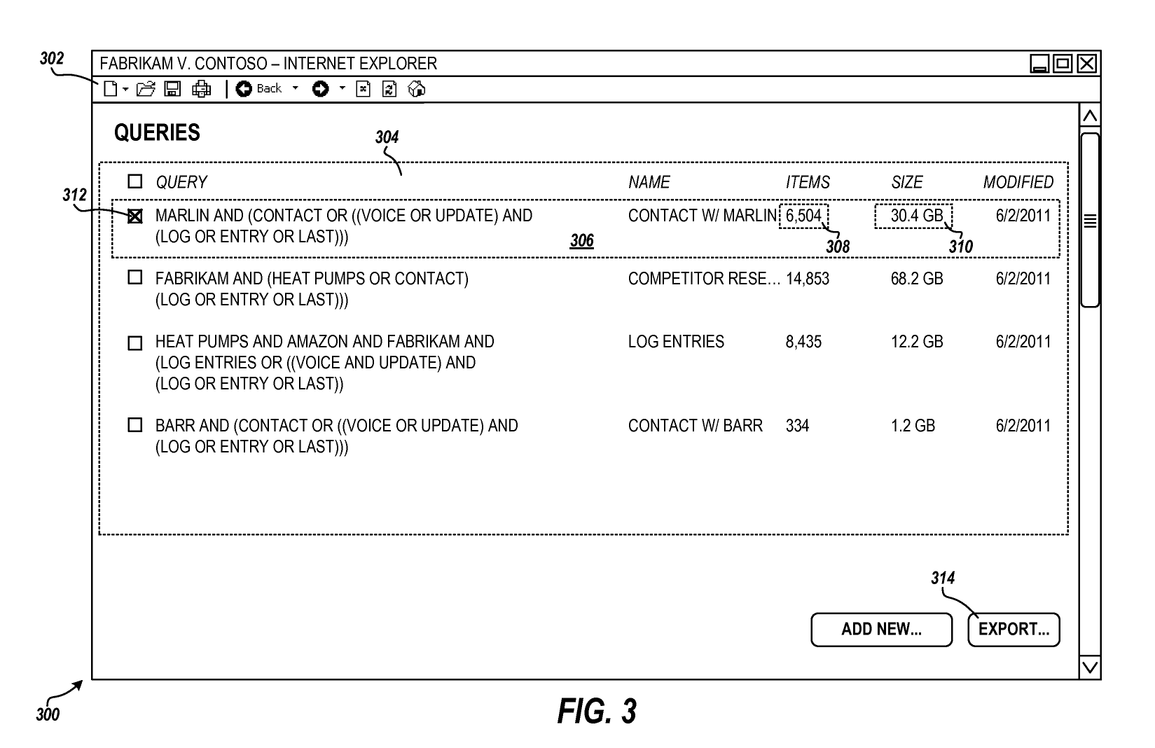

In one embodiment, a component of the e-discovery application may present a user interface (“UI”), such as the illustrative UI 300 shown in FIG. 3, to a user for selecting the desired query specifications 126. The UI 300 may be presented by the e-discovery application to the user in a browser window 302 rendered by a Web browser application executing on a user computing device, for example. The UI 300 may include a query list 304 including query entries, such as query entry 306, for each query specification 126 stored in the in the case dataset 120. Each query entry 306 may include the free-text query parameter for the query specification, a name or other identifier associated with the query specification, and the like. In addition, the query entry 306 may include query statistics, such as a total count 308 and total size 310 of content items 108 matching the query, in order to indicate to the user an overall size of the export operation before initiation of the export.

Each query entry 306 may further include a query selection control 312 that allows the user to select one or more query specifications 126 from the query list 304. The user may then select an export UI control 314 that will cause the e-discovery application to initiate the export operation in the e-discovery export client 104, identifying the query specification(s) 126 selected by the user. According to one embodiment, if multiple query specifications 126 are selected by the user, the e-discovery export client 104 will utilize an intersection of the indicated queries to locate content items 108 for export, i.e. those content items 108 that match all the query parameters from the selected query specifications. In another embodiment, the e-discovery export client 104 may utilize a union of the selected query specifications 126.

The routine 200 proceeds from operation 202 to operation 204, where the e-discovery export client 104 utilizes the query parameters from the identified query specification(s) 126 to generate one or more native search queries for each content server 112 hosting content sources 110 identified by the source specifications 124 in the combined query scope for the query specification(s). The generation of each native search query may depend on the type of content sources 110 and/or content server 112 targeted by the query, the type and capabilities of the search interface 116 provided by the content server, and the like.

For example, if the content sources 110 identified by the source specifications 124 in the query scope include one or more email mailboxes, the search interface 116 of a single email server may abstract the actual storage locations of the mailboxes containing the email messages to be searched. The e-discovery export client 104 may generate a list of mailbox IDs from the source specifications 124 in the query scope of the query specification(s) 126 and send the list along with the query parameters in a single request to the search interface 116 of the email server. For content sources 110 including one or more document libraries hosted on a content site server, the e-discovery export client 104 may make separate requests to the search interface 116 of the content site server, specifying each identified document library and the query parameters for searching the documents contained therein.

The query parameters may or may not be translated, depending on the search capabilities of the content servers 112 and/or search interfaces 116. For example, the syntax of the free-text query parameter may be converted to one supported by the content server 112. Any property/value pairs specified in the query parameters may be converted to the “propertyname:value” syntax and added to the free-text query parameter. In addition, generic query parameters, such as the date-range and/or author parameters described above, may be translated to target specific properties of the content items 108 hosted by the content server 112, such as the sent date and sender properties for email messages, or the creation date and author properties for documents, respectively. It will be appreciated that the e-discovery export client 104 may translate the query parameters from the query specification(s) 126 in other ways beyond those described herein for generation of the native search queries targeting other types of content servers 112, including web servers hosting web sites, content site servers hosting discussions, blogs, wikis, and other list-oriented sites, file servers hosting fileshares, and the like. It will be further appreciated that the examples described above are for illustration only and are not intended to be limiting.

The routine 200 proceeds from operation 204 to operation 206 where the e-discovery export client 104 executes the generated native search queries against each content server 112 and receives the query results. According to one embodiment, the e-discovery export client 104 may execute the native search queries against different content servers 112 or multiple queries targeting the same content server concurrently, allowing for efficient generation of the query results. As described above, the e-discovery export client 104 may utilize the search interface 116 provided by each content server 112 to request execution of the native search query. The e-discovery export client 104 may then receive query results from each content server 112 comprising a list of content items 108 from the content sources 110 matching the query parameters.

From operation 206, the routine 200 proceeds to operation 208, where the e-discovery export client 104 builds the export manifest 128 from the query results received from the content servers 112. The export manifest 128 may include an identifier of each matching content item 108 as well as location, i.e. content source 110 and/or content server 112, from which the content item may be retrieved. In some instances, the query results received from a content server 112 may be de-duplicated by the content server, i.e. may represent a list of unique content items 108 located in the content source(s) 110 hosted by the content server. For example, an email server may retrieve only unique email messages across the email mailboxes specified. If the same email message was found in multiple mailboxes, the email server may identify only one of copy of the message in the query results. Similarly, a content site server may only return one version of a document from a document library where multiple, duplicate versions of the document exist, or where multiple copies of the same version of the document are included in different document libraries on the content site server.

In another embodiment, de-duplication of the query results may be performed by the e-discovery export client 104. For example, an email server may generate a hash from the content of each matching email message and return the hash with the identifier of the matching email message in the query results. In processing the query results from the email server, the e-discovery export client 104 may detect matching hashes from email messages from two different email mailboxes or from the same mailbox, and only list one of the duplicate email messages in the export manifest 128 for export. In other embodiments, de-duplication of the query results may be performed on the content server 112, by the e-discovery export client 104, or by some combination of the two on a content source 110 by content source basis, depending on the capabilities of the various content servers 112 involved. Additional data reduction methods may also be implemented by the content servers 112 and/or e-discovery export client 104, such as thread-compression of email message from the same email mailbox.

According to one embodiment, all content items 108 in content sources 110 identified by the source specifications 124 in the query scope that cannot be searched by the content server 112 may be returned in the query results. For example, a content item 108 that has not yet been indexed by the content server 112, or that is encrypted, password protected, or otherwise inaccessible by the search engine of the content server, may be returned in the query results despite not matching the query parameters. The content server 112 may indicate this condition with the identification of the content item 108 in the query results, so that the e-discovery export client 104 may perform special handling of the content item during retrieval, as will be described below. In another embodiment, a user may be able to review the export manifest 128 before retrieval of the content items 108 identified therein is initiated in the e-discovery export client 104. For example, the export manifest 128 may be stored as a CSV file which may be loaded by the user into a spreadsheet application or other data viewer/analysis tool to ensure the size and scope of the content is correct before initiating the export.

The routine 200 proceeds from operation 208 to operation 210, where the e-discovery export client 104 retrieves the content items 108 listed in the export manifest 128 from the corresponding content servers 112 and stores the retrieved items in the export repository 130. According to one embodiment, the e-discovery export client 104 may initiate content item retrieval on multiple, different content servers 112 concurrently. For example, the e-discovery export client 104 may create a separate thread of execution for retrieval of items from each content server 112. As described above, the e-discovery export client 104 may utilize the item retrieval interface 118 provided by each corresponding content server 112 to export the content items 108 hosted on that server.

Some content servers 112 may support a “smart export” of content items. For example, the e-discovery export client 104 may make a single request for export of email messages to the item retrieval interface 118 of an email server, specifying a list of email message IDs along with a filename, location, and file type of an email archive file for the email messages, such as a MICROSOFT® OUTLOOK® personal folders (.PST) file. The email server may retrieve the identified email messages and store them in the specified email archive file. The e-discovery export client 104 may then store the email archive file containing the email messages in the export repository 130. In one embodiment, the e-discovery export client 104 may retrieve and store a separate email archive file in the export repository 130 for each specific email mailbox. In another embodiment, the e-discovery export client 104 may store a single email archive file in the export repository 130 containing all exported email messages from the content server 112.

Other content servers 112 may require that each individual content item 108 specified in the export manifest 128 be retrieved individually. For example, the e-discovery export client 104 may download individual files or documents from a document library hosted on a content site server using a conventional item retrieval interface 118 of the content site server, such as HTTP. The e-discovery export client 104 may then store the downloaded files individually in the export repository 130 along with any associated context data retrieved. It will be appreciated that the method of retrieval of content items 108 for the content servers 112 and the method of storage of the items in the export repository 130 will vary depending on the type of content source 110, the capabilities of the item retrieval interface 118 of the content server, the requirements of the format of the export repository, and the like.

In another example, the e-discovery export client 104 may make separate requests to the item retrieval interface 118 of a content site server for each individual list item or batches of list-oriented items, such as discussion entries, blog posts, wiki entries, and the like, in a specific content source 110 hosted on the content site server. The e-discovery export client 104 may then store all of the retrieved list items for the content source 110 in a single file in the export repository 130, such as a CSV file or XML file. In a further example, the e-discovery export client 104 may make separate requests to the item retrieval interface 118, e.g. using HTTP, of a Web server for each individual webpage hosted on the Web server specified in the export manifest 128. The e-discovery export client 104 may then store each webpage in the export repository 130 as an archived webpage (.MHT) file. Other examples of retrieval and storage methods for different types of content items 108 will become apparent to one skilled in the art upon reading of this disclosure, and it is intended that all such methods be included in this application.

According to further embodiments, the e-discovery export client 104 may apply additional processing to the retrieved content items 108 before storing the items in the export repository 130. For example, the e-discovery export client 104 may remove any encryption, rights management services (“RMS”) metadata, and the like from each file or document retrieved from the content servers 112. In addition, when downloading multiple versions of documents, e.g. from a document library, the e-discovery export client 104 may download version metadata regarding each version for inclusion in the contents listing 132 in the export repository 130. In addition, each version of the document may be given a different filename in the export repository 130, such as “<filename>_{—}99” or the like. In one embodiment, the stripping of encryption or RMS metadata, the processing of versions of documents, and other additional processing may be performed based on configuration parameters supplied to the e-discovery export client 104 by a user, for example.

As described above, the export manifest 128 may further list content items 108 from content sources 110 included in the query scope that could not be searched by the content server 112, because the content item has not yet been indexed by the content server, is encrypted, is password protected, or the like. In one embodiment, these items may be retrieved by the e-discovery export client 104 and stored in a separate directory, folder, or email archive file in the export repository 130, indicating that these content items 108 may or may not be relevant based on the search query applied.

As further described above, the export repository 130 may be organized as a virtual file system, with a directory hierarchy grouping exported content items 108 of the same type, from the same content source 110, from the same content server 112, and the like. In one example, the e-discovery export client 104 may make a request through the retrieval interface 118 of a content site server to retrieve all identified content items 108, e.g. content pages, documents, list items, etc., from a particular content site. The e-discovery export client 104 may then store the retrieved content items 108 in a hierarchical directory structure in the export repository 130 that reflects the organization of the sub-sites, document libraries, content pages, and the like in the particular content site.

As each retrieved content item 108 is added to the export repository 130, the e-discovery export client 104 may add an entry in the contents listing 132 comprising the location of the content item in the repository and other metadata regarding the item. As further described above, the contents listing 132 may comprise an XML file in the EDRM format. Additionally, the e-discovery export client 104 may add custom XML tags to the EDRM-based contents listing 132 file in order to support additional metadata information, such as a version of the content item 108 retrieved from a document library supporting versioning of files.

Because the export manifest 128 may be very large, listing tens or hundreds of thousands of content items 108, the retrieval/storage operation 210 may be a lengthy process. A user may wish to execute the operation only during non-peak hours for the content servers 112. Or, a user executing the e-discovery export client 104 on a laptop may wish to relocate the laptop to another location/network in the middle or the operation. The e-discovery export client 104 further provides the user with the ability to pause execution of the retrieval/storage operation 210 and to resume the operation at a later time, according to one embodiment. The export manifest 128 may include status information regarding each listed content item 108 to facilitate the pausing and resuming of the retrieval/storage operation 210. The pause and resume feature of the retrieval/storage operation 210 may also be used to recover from a retrieval error, for example.

In another embodiment, the export manifest 128 may include a last export date or other data for each listed content item 108 or groups of content items indicating the last date and time that the item(s) were retrieved and stored in the export repository 130. The last export date may allow the e-discovery export client 104 to support an incremental export of content items 108 in the content sources 110 specified in the query scope that have been modified or added to the content sources since the last download. Content items 108 modified or added to the content sources 110 may be identified through a subsequent execution of the native search queries of the content servers 112, retrieved, and stored in the same export repository 130 or a different export repository, depending on the requirements of the user. In a further embodiment, the export manifest 128 and/or export repository 130 may maintain a hash generated from the contents of each content item 108 exported. These hashes may be utilized in subsequent executions of the native search queries of the content servers 112 to support incremental export of content items 108 in the content sources 110. From operation 210, the routine 200 ends.

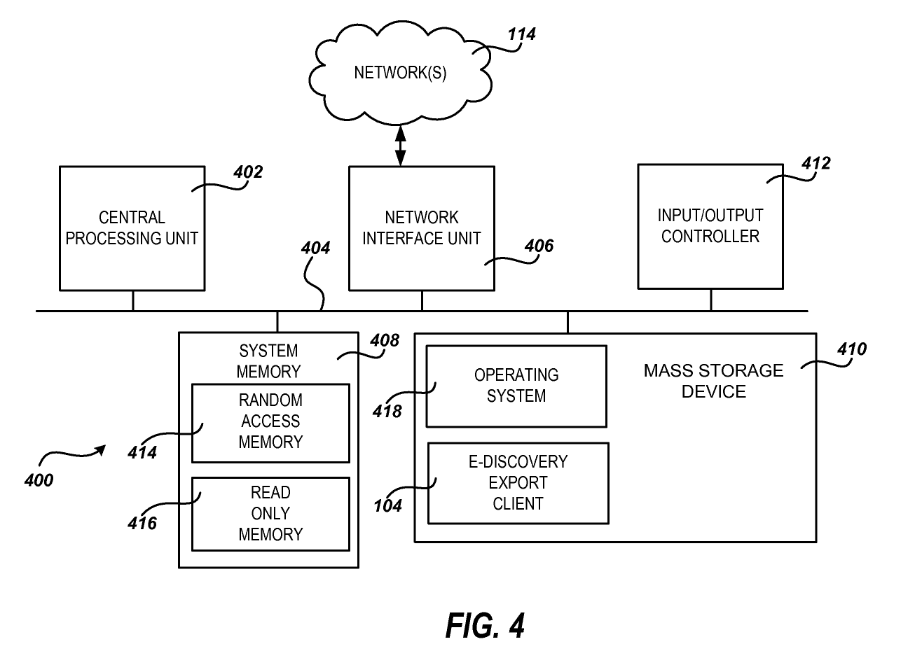

FIG. 4 shows an example computer architecture for a computer 400 capable of executing the software components described herein for exporting content items from multiple disparate content sources to a single repository, in the manner presented above. The computer architecture shown in FIG. 4 illustrates a server computer, a conventional desktop computer, laptop, notebook, tablet, PDA, wireless phone, or other computing device, and may be utilized to execute any aspects of the software components presented herein described as executing on the computer system 102 and/or other computing devices.

The computer architecture shown in FIG. 4 includes one or more central processing units (“CPUs”) 402. The CPUs 402 may be standard processors that perform the arithmetic and logical operations necessary for the operation of the computer 400. The CPUs 402 perform the necessary operations by transitioning from one discrete, physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits, including registers, adders-subtractors, arithmetic logic units, floating-point units, and other logic elements.

The computer architecture further includes a system memory 408, including a random access memory (“RAM”) 414 and a read-only memory 416 (“ROM”), and a system bus 404 that couples the memory to the CPUs 402. A basic input/output system containing the basic routines that help to transfer information between elements within the computer 400, such as during startup, is stored in the ROM 416. The computer 400 also includes a mass storage device 410 for storing an operating system 418, application programs, and other program modules, which are described in greater detail herein.

The mass storage device 410 is connected to the CPUs 402 through a mass storage controller (not shown) connected to the bus 404. The mass storage device 410 provides non-volatile storage for the computer 400. The computer 400 may store information on the mass storage device 410 by transforming the physical state of the device to reflect the information being stored. The specific transformation of physical state may depend on various factors, in different implementations of this description. Examples of such factors may include, but are not limited to, the technology used to implement the mass storage device, whether the mass storage device is characterized as primary or secondary storage, and the like.

For example, the computer 400 may store information to the mass storage device 410 by issuing instructions to the mass storage controller to alter the magnetic characteristics of a particular location within a magnetic disk drive, the reflective or refractive characteristics of a particular location in an optical storage device, or the electrical characteristics of a particular capacitor, transistor, or other discrete component in a solid-state storage device. Other transformations of physical media are possible without departing from the scope and spirit of the present description. The computer 400 may further read information from the mass storage device 410 by detecting the physical states or characteristics of one or more particular locations within the mass storage device.

As mentioned briefly above, a number of program modules and data files may be stored in the mass storage device 410 and RAM 414 of the computer 400, including an operating system 418 suitable for controlling the operation of a computer. The mass storage device 410 and RAM 414 may also store one or more program modules. In particular, the mass storage device 410 and the RAM 414 may store the e-discovery export client 104, which was described in detail above in regard to FIG. 1. The mass storage device 410 and the RAM 414 may also store other types of program modules or data.

In addition to the mass storage device 410 described above, the computer 400 may have access to other computer-readable media to store and retrieve information, such as program modules, data structures, or other data. It should be appreciated by those skilled in the art that computer-readable media may be any available media that can be accessed by the computer 400, including computer-readable storage media and communications media. Communications media includes transitory signals. Computer-readable storage media includes volatile and non-volatile, removable and non-removable media implemented in any method or technology for the storage of information, such as computer-readable instructions, data structures, program modules, or other data. For example, computer-readable storage media includes, but is not limited to, RAM, ROM, EPROM, EEPROM, flash memory or other solid state memory technology, CD-ROM, digital versatile disks (DVD), HD-DVD, BLU-RAY, or other optical storage, magnetic cassettes, magnetic tape, magnetic disk storage or other magnetic storage devices, or any other medium that can be used to store the desired information and that can be accessed by the computer 400.

The computer-readable storage medium may be encoded with computer-executable instructions that, when loaded into the computer 400, may transform the computer system from a general-purpose computing system into a special-purpose computer capable of implementing the embodiments described herein. The computer-executable instructions may be encoded on the computer-readable storage medium by altering the electrical, optical, magnetic, or other physical characteristics of particular locations within the media. These computer-executable instructions transform the computer 400 by specifying how the CPUs 402 transition between states, as described above. According to one embodiment, the computer 400 may have access to computer-readable storage media storing computer-executable instructions that, when executed by the computer, perform the routine 200 for exporting content items from multiple disparate content sources to a single repository described above in regard to FIG. 2.

According to various embodiments, the computer 400 may operate in a networked environment using logical connections to remote computing devices and computer systems through one or more networks 114, such as a LAN, a WAN, the Internet, or a network of any topology known in the art. The computer 400 may connect to the network 420 through a network interface unit 406 connected to the bus 404. It should be appreciated that the network interface unit 406 may also be utilized to connect to other types of networks and remote computer systems.

The computer 400 may also include an input/output controller 412 for receiving and processing input from one or more input devices, including a keyboard, a mouse, a touchpad, a touch-sensitive display, an electronic stylus, or other type of input device. Similarly, the input/output controller 412 may provide output to a display device, such as a computer monitor, a flat-panel display, a digital projector, a printer, a plotter, or other type of output device. It will be appreciated that the computer 400 may not include all of the components shown in FIG. 4, may include other components that are not explicitly shown in FIG. 4, or may utilize an architecture completely different than that shown in FIG. 4.

Based on the foregoing, it should be appreciated that technologies for exporting content items from multiple disparate content sources to a single repository are provided herein. Although the subject matter presented herein has been described in language specific to computer structural features, methodological acts, and computer-readable storage media, it is to be understood that the invention defined in the appended claims is not necessarily limited to the specific features, acts, or media described herein. Rather, the specific features, acts, and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed is:

1. A system for exporting content items from a plurality of content sources across different content servers, the system comprising:
one or more processors;
a memory coupled to the one or more processors; and
an e-discovery export client residing in the memory and comprising computer-executable instructions that, when executed by the one or more processors, cause the system to
receive query parameters and a query scope for locating the content items, the query scope comprising content sources hosted by at least two content servers of different types,
generate a native search query for each of the at least two content servers based on the query parameters,
execute the native search query on each of the at least two content servers and receive query results,
build an export manifest from the query results, the export manifest listing the content items for export,
retrieve the content items listed in the export manifest from the at least two content servers, and
store the retrieved content items in an export repository.

2. The system of claim 1, wherein retrieval of the content items from the at least two content servers is performed concurrently.

3. The system of claim 1, wherein the export repository is organized as a virtual file system.

4. The system of claim 3, wherein the export repository comprises a contents listing file in the Electronic Discovery Reference Model format indicating an identifier and location of each content item stored in the export repository.

5. The system of claim 1, wherein a first of the at least two content servers comprises an email server and a second of the at least two content servers comprises a content site server.

6. A computer-implemented method for exporting content items, the method comprising:
receiving query parameters for locating the content items hosted by one or more content servers;
executing a native search query of each of the one or more content servers based on the query parameters;
building an export manifest listing the content items for export from query results received from the one or more content servers;
retrieving the content items listed in the export manifest from the one or more content servers; and
storing the retrieved content items in an export repository.

7. The computer-implemented method of claim 6, wherein one of the one or more content servers comprises an email server.

8. The computer-implemented method of claim 7, wherein a plurality of email messages are retrieved from the email server and stored in a single email archive file in the export repository.

9. The computer-implemented method of claim 6, wherein one of the one or more content servers comprises a content site server.

10. The computer-implemented method of claim 9, wherein a plurality of list items are retrieved from the content site server and stored in a single file in the export repository.

11. The computer-implemented method of claim 6, wherein one of the one or more content servers comprises a Web server and wherein a complete webpage is retrieved from the Web server and stored as a single archived webpage file in the export repository.

12. The computer-implemented method of claim 6, wherein a plurality of versions of a single document hosted by one the one or more content servers are retrieved and stored in the export repository.

13. The computer-implemented method of claim 6, wherein the export repository is organized as a virtual file system.

14. The computer-implemented method of claim 6, wherein the export repository comprises a contents listing file in the Electronic Discovery Reference Model format indicating an identifier and location of each content item stored in the export repository.

15. The computer-implemented method of claim 6, wherein a content item hosted by the one or more content servers that cannot be indexed for searching is returned in the query results, retrieved from the content server, and stored in the export repository.

16. The computer-implemented method of claim 6, wherein the export manifest comprises a status for each of the listed content items, the method further comprising:
pausing the retrieval of the content items; and
resuming the retrieval of the content items at a subsequent time based on the status of each of the listed content items.

17. A computer-readable storage medium encoded with computer-executable instructions that, when executed by a computer, cause the computer to:
execute a search query of one or more content servers based on same query parameters for locating content items hosted on the one or more content servers for export;
build an export manifest listing the content items for export from query results received from the one or more content servers;
concurrently retrieve the content items listed in the export manifest from the one or more content servers; and
store the retrieved content items in an export repository.

18. The computer-readable storage medium of claim 17, wherein the export repository is organized as a virtual file system.

19. The computer-readable storage medium of claim 17, wherein the computer-readable storage medium is encoded with further computer-executable instructions that cause the computer to:
upon storing a first retrieved content item in the export repository, add an entry in a contents listing file in the export repository, the entry indicating an identifier and location of the first retrieved content item stored in the export repository.

20. The computer-readable storage medium of claim 17, wherein a first of the one or more content servers comprises an email server and a second of the one or more content servers comprises a content site server.
